(19) United States
(12) Patent Application Publication
(10) Pub. No.: US 2023/0333262 A1
(43) Pub. Date: Oct. 19, 2023

(54) PRECISION TRACKING CONTROL TECHNIQUES FOR SMART TROLLEY

(71) Applicant: Collie Technologies Inc., Ansan-si (KR)

(72) Inventor: Inhwan PARK, Ansan-si (KR)

(73) Assignee: Collie Technologies Inc., Ansan-si (KR)

(21) Appl. No.: 17/994,410

(22) Filed: Nov. 28, 2022

(30) Foreign Application Priority Data
Apr. 19, 2022 (KR) 10-2022-0048153

(51) Int. Cl. G01S 19/39; G01S 19/43; G05D 1/02

(52) U.S. Cl. CPC G01S 19/393; G01S 19/43; G05D 1/0278

(57) ABSTRACT

The present disclosure relates to a technique for controlling precise tracking of a smart trolley. More particularly, the present disclosure relates to a technique for controlling precise tracking of a smart trolley, wherein corrected values of the coordinates of the trolley and an operator are obtained by using two Kalman filters so that the trolley tracks the operator based on the difference between the corrected values of the coordinates, thereby enabling the trolley to track the operator more precisely.

### CROSS-REFERENCE TO RELATED APPLICATIONS

This application claims the benefit of Korean patent application no. 10-2022-0048153 filed on Apr. 19, 2022, which is incorporated herein by reference for all purposes as if fully set forth herein.

### TECHNICAL FIELD

The present disclosure relates to a technique for controlling precise tracking of a smart trolley. More particularly, the present disclosure relates to a technique for controlling precise tracking of a smart trolley wherein corrected values of the coordinates of the trolley and an operator are obtained by using two Kalman filters so that the trolley tracks the operator based on the difference between the corrected values of the coordinates, thereby enabling the trolley to track the operator more precisely.

### BACKGROUND

Since a bag is generally moved on a golf cart in the course of a round of golf, after having taken a shot, a golfer playing the round returns to the cart and rides it to near the point where the fallen ball is, and then stops it and walks to the ball, carrying a golf club suitable for the distance. That is, going through such a process is inconvenient for golfers.

In order to solve this problem, a trolley that follows a user playing golf has been recently developed. Since such a trolley carries golf clubs, etc. and follows the user on the green, the user does not need to return to a golf cart to switch a golf club.

The majority of such conventional trolleys simply determine whether a user is on the left or right side of the trolley based on a measuring sensor attached thereto. Alternatively, after the trolley simply measures a distance by using a distance measuring sensor attached thereto and determines its own position relative to the user, it reduces the distance while moving toward the user.

However, in this conventional method, it is difficult to accurately measure the location of a user moving randomly, so a number of errors in measuring the location are caused and the trolley is not able to track the user seamlessly.

Another problem is that seamless tracking of the trolley is impossible with the level of GPS-based location information currently used in smartphones.

In addition, when the position of the trolley is determined based on a general GPS signal and a user is tracked based on the position, the margin of error of the measurement based on the GPS signal is approximately 10 to 30 meters. Therefore, a large number of positioning errors occur because precise tracking of the trolley is not possible due to the fairly great margin of error.

Consequently, it is necessary to develop a technique for controlling precise tracking of a smart trolley improved over the trolley based on the existing method.

### RELATED ART DOCUMENT

### Patent Document

(Patent Document 1) Korean Patent Publication No. 10-1728705

### SUMMARY

The present disclosure relates to a technique for controlling precise tracking of a smart trolley. More particularly, the present disclosure relates to a technique for controlling precise tracking of a smart trolley, wherein corrected values of the coordinates of the trolley and an operator are obtained by using two Kalman filters so that the trolley tracks the operator based on the difference between the corrected values of the coordinates, thereby enabling the trolley to track the operator more precisely.

To achieve the purpose of the present disclosure, there is provided the technique for controlling the precise tracking of the smart trolley according to the present disclosure, including a tracked target and a movable trolley with a controller, wherein the controller includes a first filter for obtaining corrected values of the coordinates of the trolley and a second filter for obtaining corrected values of the coordinates of the tracked target, and the trolley tracks the tracked target based on the difference between the corrected values of the coordinates of the trolley and the corrected values of the coordinates of the tracked target.

The first filter of the technique according to the present disclosure includes the trolley prediction step in which a predicted value of the trolley is obtained based on a system model for the position and velocity of the trolley.

The first filter of the technique according to the present disclosure includes the trolley measurement step in which a measured value of the trolley is obtained by using information based on the real time kinematic (RTK)-GPS.

The technique according to the present disclosure includes the trolley correction step in which the corrected values of the coordinates of the trolley are obtained based on the predicted value and the measured value of the trolley and the Kalman's gain obtained by the system model for the trolley.

The second filter of the technique according to the present disclosure includes the tracked target prediction step in which a predicted value of the tracked target is obtained based on a system model for the position and velocity of the tracked target.

The second filter of the technique according to the present disclosure includes the tracked target measurement step in which a measured value of the tracked target is obtained based on the measured value of the trolley and a measured value of the polar coordinates of the tracked target measured by a sensor of the trolley.

The technique according to the present disclosure includes the tracked target correction step in which corrected values of the coordinates of the tracked target are obtained based on the predicted value and the measured value of the tracked target and the Kalman's gain obtained by the system model for the tracked target.

According to the present disclosure, it may possible that the trolley tracks the operator based on the difference between the corrected values of the coordinates obtained by the Kalman filters so that the trolley is enabled to track the operator more precisely.

In addition, since the corrected values of the coordinates of the trolley and the operator are obtained in real time by feedback, the accuracy of the measurement of the positions of the trolley and the operator is improved.

Furthermore, since the step of selecting a tracking mode is included, it may possible that, when the trolley tracks a fixed point, not the operator moving randomly, the trolley moves autonomously to the fixed point. As a result, the trolley is more convenient to use.

Meanwhile, since the step of detecting an inaccessible area and the step of detecting an obstacle are included, it may be possible to restrict the movement of the trolley and allow the trolley to bypass any inaccessible area or obstacle. As a result, the trolley is more convenient to use.

### BRIEF DESCRIPTION OF THE DRAWINGS

FIGS. 1 and 2 show a technique for controlling precise tracking of a smart trolley according to an embodiment of the present disclosure.

FIG. 3 shows the step of obtaining corrected values of the coordinates of the trolley by a first filter according to an embodiment of the present disclosure.

FIG. 4 shows the step of obtaining corrected values of coordinates of an operator by a second filter according to an embodiment of the present disclosure.

FIG. 5 shows the control steps of the technique for controlling the precise tracking of the smart trolley according to an embodiment of the present disclosure,

FIG. 6 shows the control steps of a technique for controlling precise tracking of a smart trolley according to another embodiment of the present disclosure.

FIG. 7 shows the step of detecting an inaccessible area.

FIG. 8 shows the step of detecting an obstacle.

### DETAILED DESCRIPTION

Hereinafter, a detailed description will be provided with reference to the appended drawings of the present disclosure. The embodiments described below are provided as examples so that the technology of the present disclosure can be sufficiently conveyed to a person having ordinary skill in the art. Accordingly, the present disclosure is not limited to the embodiments described below and may be embodied in other forms. In addition, in the drawings, the size, thickness, etc. of a device may be exaggerated for convenience of description. A certain reference numeral appearing throughout this specification consistently refers to its corresponding component.

Advantages and features of the present disclosure and methods of achieving them will be clearly understood with reference to the embodiments described below in detail based on the accompanying drawings. However, the present disclosure is not limited to the embodiments disclosed below and will be embodied in various different forms, and the embodiments are provided only to make the present disclosure complete and enable a person having ordinary skill in the technical field to which the present disclosure belongs to fully understand the scope of the present disclosure. Therefore, the present disclosure is defined only by the scope of the claims. A certain reference numeral appearing throughout this specification consistently refers to its corresponding component. The sizes and relative sizes of layers and areas in the drawings may be exaggerated for clarity of description.

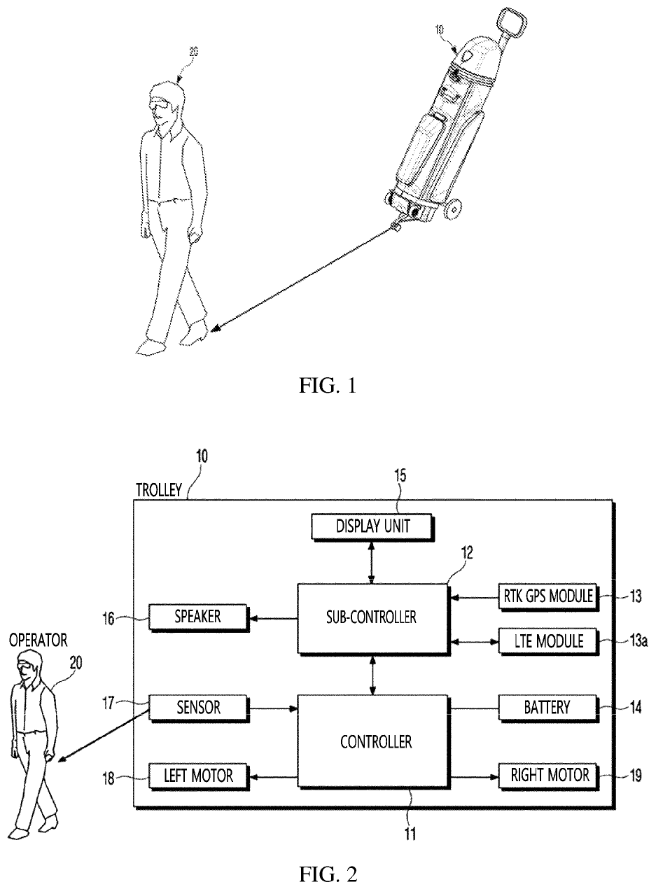

FIGS. 1 and 2 show a technique for controlling precise tracking of a smart, trolley according to an embodiment of the present disclosure.

The technique for controlling the precise tracking of the smart trolley according to an embodiment of the present disclosure may consist largely of a trolley 10 and a tracked target. The tracked target may include an operator 20, for example. Here, the operator may be in the form of a receiver that is carried and continuously moved during a round by a user playing golf as shown in 1.

Alternatively, when the operator 20 continues to stay in a specific area and does not move, an optimal trajectory from the trolley to the operator 20 may be set so that the trolley may autonomously move along the trajectory. In addition, the operator 20 may be in the form of an anchor fixed and installed at a specific point. A detailed description thereof will be provided below.

The trolley 10 may be movable and may include a controller 11, a sub-controller 12, a real time kinematic (RTK) GPS module 13, an LTE module 13a, a battery 14, a display 15, a speaker 16, a sensor 17, a left motor 18, and a right motor 19.

The controller 11 may include a first filter and a second filter, and may generate corrected values of coordinates to be described below.

The sub-controller 12 may be interlocked with the RTK GPS module 13, the LTE module 13a, the display 15, and the speaker 16, and may also be interlocked with the controller 11.

The RTK GPS module may be a GPS module that introduces the concept of real-time mobile positioning, and may refer to a module that obtains accurate positioning results in real time from a mobile station by using a corrected value for a carrier phase of a reference station that has information on a precise location. In the case of the existing GPS module, various errors may occur due to the ionosphere, the atmosphere, satellite errors, etc. However, in the case of the RTK GPS module, it may possible to reduce a margin of error to 1-2 cm by compensating for the degradation of positional accuracy due to signal distortion and delay occurring when a GPS satellite signal passes through the ionosphere.

Therefore, in the present disclosure, location information received by the RTK GPS module 13 may be used as a measured value or an observed value of the location of the trolley 10, and the step of obtaining corrected values of coordinates based on the measured value will be described below.

Well-known products may be used for the display 15, the speaker 16, and the battery 14, and the characteristics of the sensor 17, the left motor 18, and the right motor 19 will be described below. In this case, various sensors such as a camera sensor, a UWB sensor, a radar sensor, and a lidar sensor may be selected as the sensor 17.

The present disclosure is characterized in that corrected values of the coordinates of the trolley 10 may be obtained by using the first filter A in the controller 11 and corrected values of the coordinates of the operator 20 may be obtained by using the second filter B in the controller 11 so that the trolley 10 may track the operator 20 based on the difference between the corrected values of the coordinates of the trolley 10 and the corrected values of the coordinates of the operator 20. This is to improve the precision in tracking the operator by the trolley.

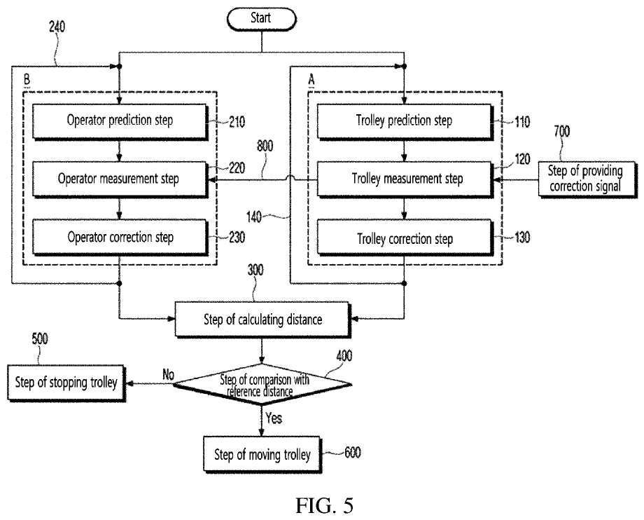

Reference will be made to FIGS. 3 and 5. FIG. 3 shows the step of obtaining corrected values of the coordinates of the trolley by the first filter according to an embodiment of the present disclosure, and FIG. 5 shows the control steps of the technique for controlling the precise tracking of the smart trolley according to an embodiment of the present disclosure. Hereinafter, the step of obtaining the corrected values of the coordinates of the trolley by the first filter according to the present disclosure will be described with reference to FIGS. 3 and 5.

The step of obtaining the corrected values of the coordinates of the trolley by the first filter according to the present disclosure may include the trolley prediction step 110, the trolley measurement step 120, and the trolley correction step 130. The method of calculating an estimated value by the Kalman filter is applied here.

Hereinafter, a system model and a measurement model for applying the first filter will be described. In addition, final corrected values of coordinates estimated based on the system model and the measurement model and the Kalman filter's gain will be described below.

The system model for the first filter may be as follow, and the trolley prediction step 110 may be performed based on the system model.

xₖ=Φ₍ₖ₋₁₎x₍ₖ₋₎+w₍ₖ₋₁₎ [Equation 1]

“w₍ₖ₋₎” denotes the process noise “Q,” and the process noise follows the Gaussian distribution as below.

wₖ˜N(O,Qₖ) [Equation 2]

For example, “w₍ₖ₋₁₎” denotes a noise caused by the system being not linear and reflects a variable occurring when the trolley moves to another position.

It may be desirable that “xₖ” reflects the two factors of position and velocity, and “k−1” and “k” denote division by time.

In the trolley prediction step 110, the next input value may be predicted with a previous data. Furthermore, this step may include the covariance calculation step of calculating the variance of the predicted value.

The predicted value at the time “k” in the trolley prediction step 110 may be as follows.

\hat{x}ₖ(−)=Φ₍ₖ₋₁₎\hat{x}₍ₖ₋₁₎(+) [Equation 3]

In this case. “−” denotes the state before measurement, and “+” denotes the state after measurement. Since the input value has already been measured at the previous time “k−1,” it may be in the “+” state.

In addition, a variance value according to the covariance matrix may be as follows.

Pₖ(−)=Φ₍ₖ₋₁₎P₍ₖ₋₁₎Φ₍ₖ₋₁₎T+Q₍ₖ₋₁₎ [Equation 4]

Next, the measurement model for the first filter may be as follows. The trolley, measurement step 120 may be proceeded by the measurement model, and, in this step, a measured value may be obtained by the RTK GPS module 13.

zₖ=Hₖxₖ+vₖ [Equation 5]

“vₖ” denotes the measurement noise “R,” and the measurement noise may follow the Gaussian distribution as follows.

vₖ˜N(O,Rₖ) [Equation 6]

For example, “vₖ” denotes the noise of an RTK GPS signal. That is, it is an error by a measuring device.

An optimal output value may be obtained according to the following model following the system model and the measurement model, and, in the trolley correction step 130, final corrected values of the coordinates, i.e., the optimal output value, of the trolley may be obtained according to the following model. The principle of the exponential moving average filter is adopted here.

\hat{x}ₖ(+)=\hat{x}ₖ(−)+Kₖ[zₖ−Hₖ\hat{x}ₖ(−)] [Equation 7]

In addition, variance values according to the covariance matrix resulting from the system model and the measures ent model may be as follows.

Pₖ(+)=[I−KₖHₖ]Pₖ(−) [Equation 8]

The Kalman filter's gain obtained by the aforementioned process may be as follows. A measured value may be more reliable when the Kalman filter's gain is large, and a predicted value may be more reliable when the Kalman filter's gain is small. The Kalman filter's gain may be obtained by the process of differentiating a variance.

_{*95}Lₖ=Pₖ(−)Hₖ^{T}[HₖPₖ(−)Hₖ^{T}+Rₖ]⁻¹ [Equation 9]

Therefore, the input and the output of the first A according to the present disclosure may be summarized as follows.
Input: \hat{x}₍ₖ₋₁₎(+),zₖ,P₍ₖ₋₁₎
Output: xₖ(+), Pₖ(+)
*101

In addition, according to the present disclosure, the output value may be fed back to be input back in the prediction step so that the returned value of \hat{x}ₖ(+), Pₖ(+) may become an input value back.

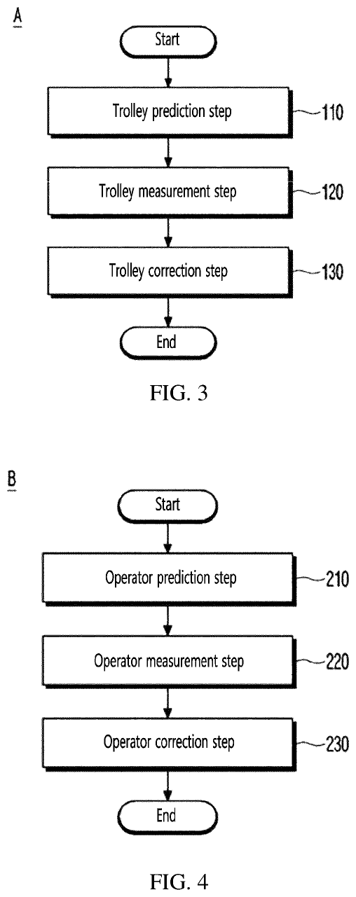

Reference will be made to FIGS. 4 and 5. FIG. 4 shows the step of obtaining corrected values of the coordinates of the operator by the second filter according to an embodiment of the present disclosure, and FIG. 5 shows the control steps of the technique for controlling the precise tracking of the smart trolley according to an embodiment of the present disclosure. Hereinafter, the step of obtaining the corrected values of the coordinates of the operator by the second filter according to the present disclosure will be described with reference to FIGS. 4 and 5.

The step of obtaining corrected values of the coordinates of the operator by the second filter B according to the present disclosure may include the operator prediction step 210, the operator measurement step 220, and the operator correction step 230. The method of calculating an estimated value by the Kalman filter is applied here. Accordingly, the same method as the method applied to the first filter is used, and the difference is in calculating a measured value.

Therefore, the method of calculating a measured value will be described as follows, but, since the other steps are the same as those for the first filter, descriptions thereof will not be repeatedly provided.

The first filter A and the second filter B may respectively go through the Kalman filter, and the second filter B may be characterized by receiving a measured value of the trolley 10 by the RTK GPS module 13 from the first filter A. That is, it may be possible to improve the precision in tracking the operator 20 by the trolley 10 by reflecting the measured value of the trolley 10 in the second filter B in real time, apart from obtaining corrected values of the coordinates by the filters.

A measurement model for the second filter according to the above-mentioned principle may be as follows. The operator measurement step 220 may be proceeded based on the measurement model, “H_{o,k}” in the following equation is to distinguish the trolley from the operator.

z_{o,k}=H_{o,k}X_{o,k}+v_{o,k} [Equation 10]

“x_{o,k}” and “y_{o,k},” which are the components of “X_{o,k},” may be derived as below.

x_{o,k}=x_{t,k}+rₖ cos θₖ [Equation 11]

y_{o,k}=y_{t,k}+rₖ sin θₖ [Equation 12]

Here, “x_{t,k}” and “y_{t,k}” are measured values of the trolley measured by the RTK GPS module 13, and “rk” and “θₖ” are measured values of the polar coordinates of the operator 20 measured by the sensor 17 attached to the trolley 10. Therefore, since the values of the polar coordinates measured by the sensor 17 by setting the RTK GPS module 13 as the reference coordinate may be reflected in a measured value of the operator 20, it may be possible to calculate the measured value of the operator 20 in real time so that the interconnectivity and the precision of the tracking may be improved.

Next, the step 300 of calculating the distance between the trolley and the operator will be described with reference to FIG. 5.

Corrected values of the coordinates of the 10 obtained by the first filter A may be as follows.

\hat{x}_{t,k}(+) and ŷ_{t,k}(+)

In addition, corrected values of the coordinates of the operator 20 obtained by the second filter B may be as follows.

\hat{x}_{o,k}(+) and ŷ_{o,k}(+)

Here, “rₖ,” which is an absolute value of the distance between the trolley and the operator, may be as below.

rₖ={square root over ((\hat{x}_{o,k}(+)−\hat{x}_{t,k}(+))²+(ŷ_{o,k}(+)−ŷ_{t,k}(+))²)}

Next, the step 400 of comparison with a reference distance will be described with reference to FIG. 5.

After the “rₖ,” which is the absolute value of the distance between the trolley and the operator, is calculated, in the step 400 of comparison with a reference distance, the absolute value may be compared with the reference value λ pre-stored in the controller 11. The process may proceed to the step 600 of moving a trolley when the “rₖ” is greater than the k, and the process may proceed to the step 500 of stopping a trolley when the “rₖ” is smaller than the k. As a result, it may be possible that a certain distance between a user and the trolley is maintained so that the trolley does not move excessively near the user in order not to disturb the user hitting a ball. In addition, it may be possible that the reference value λ is adjusted by the user so that the position of the trolley 10 may be customized for each user.

In the step 600 of moving a trolley, the displacement of the trolley 10 may be calculated, and the left motor 18 and the right motor 19 may be controlled based on the calculated displacement to move the trolley.

The displacement of the trolley 10 may be calculated as follows.

δₓ=\hat{x}_{o,k}(+)−\hat{x}_{t,k}(+) [Equation 14]

δ_{y}=ŷ_{o,k}(+)−ŷ_{t,k}(+) [Equation 15]

*151

To summarize, a system for the precise tracking of the smart trolley according to the present disclosure will be described with reference to FIG. 5.

The filtering of the first filter A and the second filter B may be respectively made and may be simultaneously performed.

In the case of the first filter A, corrected values of the coordinates of the trolley 10 may be obtained by going through the trolley prediction step 110, the trolley measurement step 120, and the trolley correction step 130. In this case, a measured value obtained in the trolley measurement step 120 may be provided in the step 700 of providing a correction signal of the RTK GPS module 13. The corrected values of the coordinates of the trolley 10 may be fed back 140 and input back in the trolley prediction step 110, and this process may be repeated so that the current position of the trolley based on the corrected values of the coordinates may be set in real time. By virtue of this feedback, it may be possible to minimize errors in setting the current position of the trolley 10.

Furthermore, in the case of the second filter B, corrected values of the coordinates of the operator 20 may be obtained by going through the operator prediction step 210, the operator measurement step 220, and the operator correction step 230. In this case, a measured value obtained in the operator measurement step 220 may be obtained based on the measured value of the trolley 10 provided 800 by the RTK GPS module 13 and values of the polar coordinates of the operator 20 measured by the sensor 17 of the trolley 10. The corrected values of the coordinates of the operator 20 may be fed back 240 and input back in the operator prediction step 210, and this process may be repeated so that the current position of the operator based on the corrected values of the coordinates may be set in real time. By virtue of this feedback, it may be possible to minimize errors in setting the current position of the operator 20.

Thereafter, after going through the step 300 of calculating the distance and the step 400 of comparison with a reference distance, the trolley may be moved 600 or stopped 500. Therefore, the corrected values of the coordinates may set based on the two Kalman filters as above, and the distance may be measured based on the corrected values, so that the trolley may be capable of tracking the operator more precisely compared to the conventional trolley.

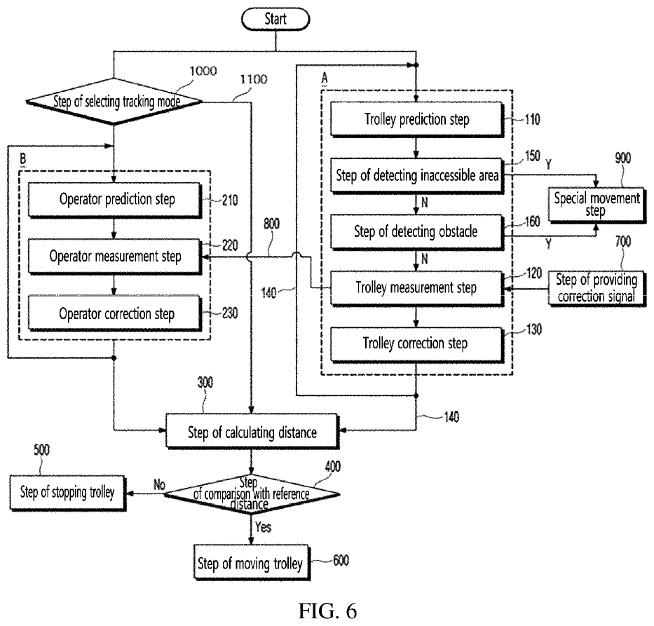

FIG. 6 shows the control steps of a technique for controlling precise tracking of a smart trolley according to another embodiment of the present disclosure.

The technique for controlling the precise tracking of the smart trolley according to another embodiment of the present disclosure may include all the features according to the previous embodiment, but may be characterized by including further steps.

First, for the first filter A, the step 150 of detecting an inaccessible area and the step 160 of detecting an obstacle may be further included.

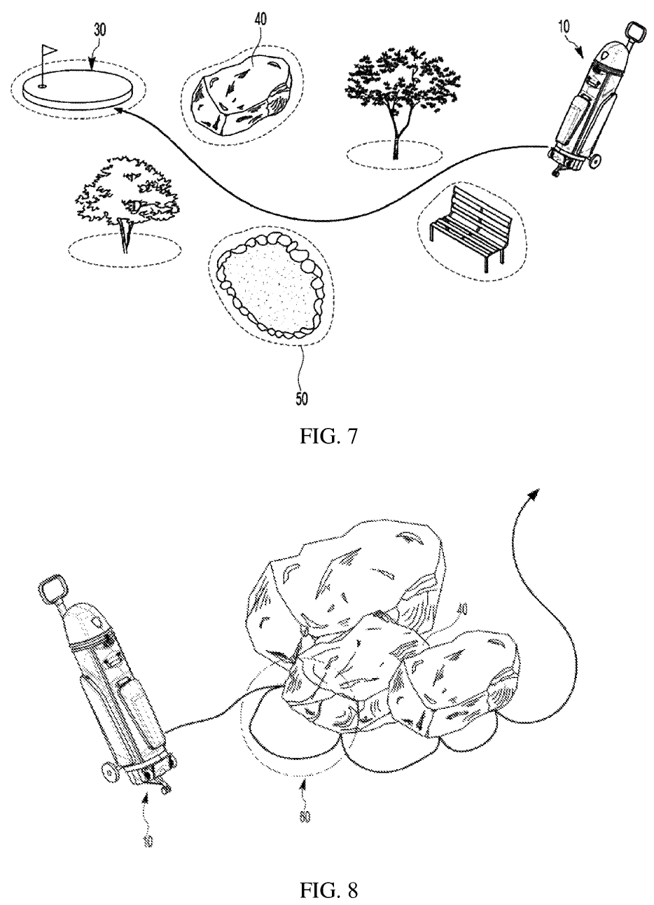

A description of the step 150 of detecting an inaccessible area will be provided with reference to FIG. 7.

In the step 150 of detecting an inaccessible area, a virtual fence for an obstacle or an inaccessible area may be formed on a map in advance to obtain values of its coordinates, and it may be determined whether corrected values of the coordinates of the trolley 10 are within the virtual fence. For example, since the trolley 10 may not be allowed to move toward a rock 40 and a hazard 50 on the green 30, the virtual fence may be formed on the rock 40 and the hazard 50 on the green 30 to set areas that the trolley 10 cannot access.

In this case, when the virtual fence is detected in the step 150 of detecting an inaccessible area, the trolley 10 may be controlled not to move near the virtual fence at all. Even when the trolley 10 has approached the virtual fence due to an error, it may be possible that the trolley 10 gets away from the virtual fence by going through the special movement step 900 to be described below.

In addition, a description of the step 160 of detecting an obstacle will be provided with reference to FIG. 8.

In the step 160 of detecting an obstacle, the trolley 10 may be temporarily stopped when an unexpected obstacle 40 for which no virtual fence has been formed is suddenly detected.

When any inaccessible area and obstacle are detected in the step 150 of detecting an inaccessible area and the step 160 of detecting an obstacle, the process may proceed to the special movement step 900. In the special movement step 900 as shown in FIG. 8, when detecting the virtual fence or the unexpected obstacle 40, the trolley 10 may repeatedly identify the location of the virtual fence or the unexpected obstacle and bypass the fence or the obstacle to get away therefrom by a method of the so-called “Bubble Rebound” 60 where the trolley 10 repeats the process of stopping first and moving while forming a circular trajectory to identify the location of the virtual fence or the obstacle again. A method of bypassing is not limited thereto and may be implemented in various forms. For example, although not shown, a method of detecting a virtual fence or an unexpected obstacle based on an ultrasonic sensor may also be possible.

In summary, when an inaccessible area, an obstacle, etc. are detected in the detecting steps and the special movement step, the trolley may avoid and bypass the inaccessible area or the obstacle automatically rather than moving manually, so that the trolley is more convenient to use.

Next, another embodiment may further include the step 1000 of selecting a tracking mode.

In the step 1000 of selecting a tracking mode, a user may be allowed to select either a tracking mode in which the trolley 10 tracks the operator 20 moving continuously and randomly or a tracking mode in which the trolley 10 tracks a target point 20 with a fixed position. That is, it may be possible to select a target to be (racked by the trolley 10 as needed when operating the trolley 10.

Since the process of tracking the operator 20 has been described above, a description thereof will not be repeated, and the process of (racking the fixed target point 20 will be described. In the process, an optimal trajectory from the trolley to the fixed target point 20 may be derived, a. UWB location anchor may be installed in the direction in which the trolley reduces the difference between location data estimated by the first filter and the optimal trajectory and may be set as a tracking reference signal, and the trolley 10 moves autonomously.

In this case, the fixed target point 20 is fixed in one position compared to the operator 20 moving continuously, and, since the distance to the target point 20 to be tracked along the optimal trajectory is a fixed value, filtering by the second filter B for tracking the target point 20 may be unnecessary. In addition, when the mode for tracking the fixed target point 20 is selected in the step 1000 of selecting a tracking mode, corrected values of the coordinates of the trolley 10 and the optimal trajectory to the target point 20 may be derived immediately, and values of the coordinates of the target point to be tracked may be calculated 1100. Meanwhile, the values of the coordinates of the target point 20 may be separately received.

Here the step 400 of comparison with a reference distance included in the previous embodiment may be skipped, and the trolley 10 may be moved immediately. Accordingly, in another embodiment, autonomous moving of the trolley 10 may be possible by setting the fixed target point 20, and an algorithm for setting an optimal path to the target point may be provided. As a result, the convenience of using the trolley may be maximized.

In the detailed description of the present disclosure above, descriptions have been made with reference to the desirable embodiments of the present disclosure, but it should be understood by a person skilled or having ordinary skill in the technical field that various modifications and variations of the present disclosure are possible within the scope of the technology of the present disclosure as set forth in the following claims. Therefore, the scope of the technology of the present disclosure is not limited to the contents described in the detailed description above but should be defined by the claims.

What is claimed is:

1. A technique for controlling precise tracking of a smart trolleys, comprising:
a tracked target; and
a movable trolley with a controller,
wherein the controller includes a first filter for obtaining corrected values of the coordinates of the trolley and a second filter for obtaining corrected values of the coordinates of the tracked target, and
the trolley tracks the tracked target based on the difference between the corrected values of the coordinates of the trolley and the corrected values of the coordinates of the tracked target.

2. The technique of claim 1,
wherein the first filter includes the trolley prediction step in which a predicted value of the trolley is obtained based on a system model for the position and velocity of the trolley.

3. The technique of claim 2,
wherein the first filter includes the trolley measurement step in which a measured value of the trolley is obtained by using information based on the real time kinematic (RTK)-GPS.

4. The technique of claim 3,
wherein the trolley correction step in which the corrected values of the coordinates of the trolley are obtained based on the predicted value and the measured value of the trolley and the Kalman's gain obtained by the system model for the trolley is included.

5. The technique of claim 4,
wherein the second filter includes the tracked target prediction step in which a predicted value of the tracked target is obtained based on a system model for the position and velocity of the tracked target.

6. The technique of claim 5,
wherein the second filter includes the tracked target measurement step in which a measured value of the tracked target is obtained based on the measured value of the trolley and a measured value of the polar coordinates of the tracked target measured by a sensor of the trolley.

7. The technique of claim 6,
wherein the tracked target correction step in which corrected values of the coordinates of the tracked target are obtained based on the predicted value and the measured value of the tracked target and the Kalman's gain obtained by the system model for the tracked target is included.
